(19) United States
(12) Patent Application Publication
(10) Pub. No.: US 2022/0084386 A1
(43) Pub. Date: Mar. 17, 2022

(54) Find Me FM

(71) Applicants: Linda Diane Flores Lopez, Fort Worth, TX (US); Linda Diane Flores Lopez, Fort Worth, TX (US)

(72) Inventors: Linda Diane Flores Lopez, Fort Worth, TX (US); Linda Diane Flores Lopez, Fort Worth, TX (US)

(21) Appl. No.: 17/019,418

(22) Filed: Sep. 14, 2020

(51) Int. Cl. G08B 21/14; G06F 21/32; H04W 4/029

(52) U.S. Cl. CPC G08B 21/14; H04W 4/029; G06F 21/32

(57) ABSTRACT

The fearful environment of our society is a daily mental and physical encounter that has been exposed greatly in these past years, creating a need to alleviate the anxieties that have overwhelmed us all, in different ways and on many levels. This has brought us face to face with intervening and developing ways to counter those fears with the Find Me FM, in a way which monitors the location and safety of wearers, with various options available; designed to provide boundary limits if needed; offers enhanced safety and security audibly, visually and geographically; possible value-added services could assist law enforcement in location of Abductees or detection of lost or stolen weapons that could be used by criminals; could assist people in location of their personal firearms by proximity range. It is designed for wearing by children, the elderly and others requiring supervision or boundary limitations, whether in a hospital, psychological facility, school or at home; can also be used to track pets & any personal mode of transportation or items you do not want lost or stolen

Leaving a child unattended in a vehicle constitutes “child endangerment” for which a parent or guardian could be prosecuted as a crime beyond the horror of having a child harmed or killed by such an event. A child unattended in a vehicle could be harmed or killed by heat stroke in an enclosed vehicle on a hot day. Likewise, in too cold of weather, a child could suffer from frostbite or even die of hypothermia if left in an extremely cold vehicle for too long. Then of course, a child, a senior, or a person with cognitive disabilities could have the potential to be abducted or wander away if left unattended in an unlocked vehicle. It also seems all too often that one hears about the abduction of children or missing persons in the news media. While this portrayal of such occurrences in the media often seems to be paired with the perception of a single and often deranged perpetrators acting in each media-reported missing person or abduction event, a much darker side to the state of world affairs can be at hand. This dark side of world affairs is known as “human trafficking.” Human trafficking is driven by greed and the oral view that humans can be illicitly bought and sold much like any other commodity. Sadly, in the 150 years since America's Civil War, human trafficking—slavery—is still present in. the United States, although not to the extent which it remains in other parts of the world. Unconvinced? Free the Slaves, a Washington, D.C. based nonprofit, has calculated the return on the cost of an enslaved field worker in 1850s Alabama at just 5 percent, whereas today a trafficked farmhand can yield the owner anywhere from double digits to 800 percent. Similarly, an imprisoned prostitute shuttled around the boroughs of New York City in a van, while a driver is scheduling appointments on his cell phone, can service as many as customers in a single shift. As one researcher coldly put it “people are a good commodity as they do not easily perish, but they can be transported over long distances and can be reused and resold. The U.S. State Department estimates that more than 27 million people are trafficked around the world. In 2010, State Department began detailing our own problem with modern-day slavery in its report. The numbers are not huge. The Bureau of Justice in Washington—the Polaris Project—reported nearly 20,000 calls for help nationally in 2012. By one estimate, human trafficking is the second most significant criminal enterprise in the world, generating as estimated $32 billion in annual revenue. The statistics for one type of human trafficking-prostitute are particularly shocking. By one estimate, more than 1,000,000 children in the United States are forced into prostitution every year. The average age of entry into prostitution in 13 years old perhaps by no coincidence that is the same age at which children start using cell phones and mobile devices. The internet and social media represent huge danger zones for children and vulnerable adults despite all their potential benefits. That is where the concept of the proposed “Find Me” could come in. SC-FM is needed for Senior Care or the Home Bound Dementia related illnesses of the elderly or those cognitively impaired in some manner. According, to WEB MD, U.S. Dementia-linked death rate more than doubles. According to The Department of Sociology and Gerontology, Miami University, Middleton, Ohio, the National Institute of Health, University of North Carolina, Chapel Hill, Mather Life Ways. The Institute on Aging, Evanston, Ill. and the Department of Sociology and the Gerontology, Miami University Oxford, Ohio, the following information was determined: “As America ages, greater numbers of older adults will be living with Alzheimer's disease or a related dementia, leading to increased incidence of wandering. Currently there are several initiatives to assist older adults who go missing. More fundamentally, the nature and scope of the missing elder problem is understudied. We call for further research into this issue, as well as assessments of how well such programs detailing our own problem with modern-day slavery in its report. The numbers are huge. balance individual liberties with safety concerns. As baby boomers enter old age, demographers predict a growth of people who live with Alzheimer's and other dementias.

The Bureau of Justice in Washington—the Polaris Project—reported nearly 20,000 calls for help nationally in 2012. By one estimate, human trafficking is the second most significant criminal enterprise in the world, generating as estimated $32 billion in annual revenue. The statistics for one type of human trafficking-prostitute are particularly shocking. By one estimate, more than 1000,000 children in the United States are forced into prostitution every year. The Alzheimer's Association estimates that 1 in 8 people over age 65 (13%) have the disease, and they project that by 2050, barring any new medical breakthrough, the number of people over age 65 with Alzheimer's Disease may triple from 5.2 million to 11 to 16 million; these estimates do not include projections for the rise in other types of dementia (Alzheimer's Association, 2011). The Alzheimer's Association (2008) also states that 6 out of 10 of people with Alzheimer's disease will eventually wander. As a result, policy makers, program developers, and political leaders are concerned about the challenges that increased wandering may cause. Wandering among individuals with dementia is a multifaceted behavior that has inspired several comprehensive reviews (Algase, Moore, Vanderweerd, & Gavin-Dreschank, 2007; Lai & Arthur, 2003; Silverstein, Flaherty, & Tobin, 2002). In essence, wandering is typified by locomotive behavior that may be purposeful (e.g., exploring a new area) or not (e.g., mindless pacing), and it may be something of which a person is aware (e.g., escaping from a place) or is unaware (e.g., meandering to fill time). Algase and colleagues (2007, p. 696) provide a provisional definition: A syndrome of dementia-related locomotion behavior having a frequent, repetitive, temporally disordered and/or spatially disoriented nature that is manifested in lapping, random and/or pacing patterns some of which are associated with eloping attempts or getting lost unless accompanied. However, we focus on what Algase and colleagues (2007) refer to as “critical wandering,” which occurs when an elder leaves an institution or home and is unaware of his or her situation in terms of place and/or time. Critical wandering exposes the person to potential dangers such as falling, traffic accidents, and/or adverse weather conditions. The feasibility of electronic tracking devices in dementia: a telephone survey and case series Survey information is associated with the following. R McShane 1, K Gedling, B Kenward, R Kenward, T Hope, R Jacoby Utilizing the present devices which do not have the features of the SC-FM, a phone survey was done to determine if it was practical to use the Method: The likely demand for an electronic tracking device was assessed by means of a telephone survey of a convenience sample of 99 carers.

The practical feasibility of a tracking system was assessed in 24 patients with dementia. Results: The telephone survey suggested that 20% of patients were at continuing risk of traffic accidents and 45% were at continuing risk of getting lost. About 7% could have benefited from using the device at the time of survey and a further 11% could have benefited at an earlier point in their illness. In the feasibility study, only nine patients consistently used the device. In two patients, it was successfully used in a search. One patient was injured by a passing vehicle when he had got lost out of range of the device. A major barrier to using the device was recognizing the risk of getting lost before it happened. Conclusion: Significant numbers of patients are at risk. Electronic tracking devices may occasionally be useful in carefully selected cases. Several different patents were sought to help in some of these situations. A better structure for the overall deterrent or prevention of what they were disclosed to do, allows for more defined accommodations for deterrents or prevention. It is estimated that 60% of arrests occurred during years 4-9: 68% within 3 years; 79% within 6 years; 83% within 9 years; 82% of those arrested 110 during the 9th year period was arrested within the 1st 3 years. The above information is from the National Institute of Justice, dated May 21, 2019. The average cost associated with one recidivism event is $118, 746; approximately $57,418 is attributed to the tangibles and intangibles borne by victims. Peter Cove is the Founder & Lee Bowes is the CEO of America Works, a national private workforce development. It was noted in an article, “Immediate Access to Employment Reduces Recidivism”, states that more than ½ million are released from federal & state jails an Manhattan Institute, an independent research organization conducted a study on recidivism and immediate employment. The study revealed a 20% reduction in the return to crime by non-violent offenders constitute most incarcerated individuals) Larry Mead, acclaimed NYC Prof, of Politics and Public Policy said “In most random social studies there are usually little to no positive effects. These results are huge.” America Works supplemental study across 6 states though uncontrolled, showed consistent and impressive data. Statewide rates of recidivism range from about 31-70%, while those placed in jobs shortly after their release ranged 3.3-8%. In High Point, N.C. only violent offenders who were identified by the police as most likely to offend were referred to them for jobs. In North Carolina statewide recidivism rates was 40% after the individuals were referred and placed in jobs, it was 5%

### DESCRIPTION OF RELATED REFERENCES

Because of these recurring problems that affect not only our children but also everyone, healthy or medically, physically, or psychologically challenged, the present concept offers additional offers that can address what is thought of as the needed means to assist all those most vulnerable, which means all of us. The U.S. Pat. No. 5,214,699 being a dedicated System of Decoding and Displaying Personalized ID stored on a Memory Device, provides a protected method of securing visual data and has a tamper proof method also to eliminate changing that information. These same features or more are used for the FM for Re-Entry individuals from prisons. Those Prison Re-entry citizens, that utilize the system units to assist them in being more cognizant of the environment and people that negatively affects their future, as well as the positive incentives the PRP FM offers the employer who hires them. (Hopefully, this will also give insurance companies an incentive for positive behavior in reducing bonds or other considered insurance liabilities in which this program can affect positively, thus in turn is a positive for communities, the people participating and companies that hire them. The PRP Multi or Singular Units can be acquired by the companies and can make them inter-changeable among the employees participating in the program. However, the individual participating can also acquire the singular unit themselves which one day maybe mandated by the court system or after satisfactory interactions and completions of certain classes etc., thus the P.O can allow these individuals to report less in person to see them (which can be detrimental, if the participant has employment), yet have communications if needed. The Parole or Probation Officer (PO) can have a multi-unit PRP. There is also the U.S. Pat. No. 5,423,574, titled Children Loss Prevention System have a bracelet of a guardian and one of a child to unite then if they are ever separated

It states that to avoid giving the child to someone he or she does not belong, it has a resistant feature that detects if the bracelet seal is broken when someone tampers with it. However, if it happens to get removed and a child is abducted all they must do is change the bracelets. It is as many of the systems to be listed next, are great systems. Something more is needed that could help with better securely of anyone with the bracelet and detection of those tampering to remove it. US Pat Application 2004/0121756 discloses a wrist worn device which includes a GPS tracking system, which transmit a signal to a remote location. U.S. Pat. No. 8,217,796 discloses a child seat safely system that includes means to alert a parent or the police via cellular means. 2015/0109/26 Pat Application discloses a child monitoring system for parents to monitor children, that is preferably in the form of a bracelet and includes a microprocessor and transceiver, a camera, a speaker, a microphone, and a GPS chip.2016/0330570 US Pat Application discloses a proximity alarm system which includes a vehicle that may have a user and a child positioned therein, that comprises a bracelet that may be worn on a wrist of the child. U.S. Pat. No. 5,978,493 discloses an identification bracelet for child and guardian matching. U.S. Pat. No. 6,396,403 discloses a child monitoring system including a combination bracelet and camera transmitting assembly and a receiver for tracking and providing audible and visual contact with a child or object within a predetermined are of domain. 2005/0211677 US Pat Application discloses a child safety alarm having a panic button which emits an audible alarm when activated. U.S. Pat. No. 8,847,747 discloses device that creates an audible alert upon the opening of a vehicle door to remind vehicle occupants to look for children before exiting the vehicle. U.S. Pat. design No. 677,190 illustrates an ornamental design for a wristband health tracker. Foreign Patent document CN205106608U discloses a child monitor bracelet wherein the display screen top is equipped with the camera. APP PCT/US 2007/072182 A multimedia device integration system with aftermarket audio/video devices integrated with exiting OEM. U.S. patent Ser. No. 10/404,476 A method and apparatus for a certificate authority system providing authenticity to a plurality of devices associated with an organization. The method may include receiving at the certificate authority system, a request from a device to sign authentication information of the device, where is the device is associated with the organization and verifying responses. U.S. patent Ser. No. 10/389,530 disclosed a method for processing content stored on a component. U.S. patent Ser. No. 10/356,122 A new device for detection and prevention of an attack on a vehicle via its communication channels. U.S. Pat. No. 345,314 Issued to Chandra shows a design with means for hooking or attaching transmitter and receiver to belt of a user's pants and has a method to activate and deactivate with a camera to capture visual images of an object. U.S. Pat. No. 4,785,291 discloses a distance monitor for child surveillance having an un modulated radio frequency transmitter carried by or affixed to the person to be monitored and receiver monitor located at a remote location for providing a visual color-coded end/or audible signal in direct proportion to the receiver transmitted signal. U.S. Pat. No. 4,899,135 Issued by Gaharian to disclose a child monitoring device with an ultra-sonic or radio monitoring system transmitting unit for the child and receiver for the guardian. The receiver alerts primarily audible transmitting device, alerts. U.S. Pat. No. 5,115,223 Issued to Moody shows a personnel location monitoring system and has an audible alarm which signals when an individual has traveled beyond preset boundaries.

Also signals such as a smoke detector signal and a satellite signals are monitored to obtain signals which indicate hazardous building or room conditions and positional data, respectively. U.S. Pat. No. 5,086,290 discloses a mobile boundary monitoring system with a battery transmitter by the transmitter and depicts a visual alarm signal when the user has gone beyond a certain area. US Pat 2204/0121756A1 discloses an individual, tracking devices more specifically related to and providing efficient notification to authorities and family that an individual is experiencing an emergency tracking system that is disguised as a conventional watch, authorizes authorities of geographical location. U.S. Pat. No. 6,583,799B discloses that a compute implemented method uploads image data to a remote computer such as a server by; defining an area in a user interface adapted to receive an image; generating a thumbnail associated with the image when the image is associated with the area; and uploading the image to the server.

### INFORMATION OF THE INVENTION

The FM has one of the simplified versions with the FM Family which has the basic components of a central processor unit, memory, input, output, networking cards, power supply, screen, wireless capability, GPS, 2-3 way or more programmable numbers, microphone, proximity alarm, volume button, record, video/audio, pairing, limited varied, camera, off and on and storage. All FM's come in various shapes and sizes for units. design and engineering of components. Some of these features are determined by design and size as well as purpose. Timer, date, month, day, text, location, messages, charging capability and indicators. Some has Bluetooth and water-resistant shell. Various FMs have additional capabilities than the Basic, such as Bluetooth, water resistant shell, proximity alarm, vibration, volume button/switch, voice command functions, ability to record extended video/audio with up-loadable capability, varied interface capabilities with vehicles, residential and commercial security systems, deletion and remote capabilities, tamper resistant feature, flashing lights as deterrent, emergency alarm, facial recognition, and attachment clip for aftermarket FM child seat and seatbelts of a child's seat and seat belt of the inside of the backseat. The clip can be attached in various ways and in different places because the sensor is based upon proximity. Additionally, regarding the FM-OCDCM comes in a portable stand alone and is included with all the sensors which detect the oxygen and carbon dioxide exchanges within the vehicles or home is included, initially, only when it is already installed when the vehicle or home is purchased. This also includes carbo monoxide detection and alarm activation, due to its deadly results in enclosed spaces such as vehicles, homes, garages, and offices. The Base Controller Unit for all aftermarket or pre-purchased installed, interfaced units has all the capabilities of all the FM's and the ability to be enhanced as technology evolves. It is the central unit in which each FM unit can be paired for all centers, rentable per visit for all entertainment venues, educational institutions, PRP Programs, inanimate objects, various sensors detect functions of units paired, remote and battery pack, activation and deactivation indicators for transmission and reception. This is not exhaustive, as additional features, operations and elements, components, and applications. This is not limited to a Specific form disclosed and does not comprise all the elements and designs various modifications needed and required for the as the experts may specify. This only provides the basic features and abilities but does not encompass all the embodiments of the FMs. The foregoing is considered only of the principle of the FM therefore items not mentioned does not eliminate suitable and needful modifications not limiting the capability of evolution as experts deem necessary for production and optimum operations of all FM Family units and includes the ability to manually, access each unit if needed. The BCU can access, individually each unit paired with it, detect if it is operating optimally, if necessary, as in the Multi FM units It has the capability of having a selection process of numbers or names or any information programmed into the system for notification purposes or transmission, or reception/units paired with another FM which has wireless capabilities with the base controller unit and can save replay, forward, store, record, focus and display what has been received through transmissions. The FM testing method occurs when the panic button inside of the enter side of the unit next to the arm is opened and pressed. It will beep once is you hold it for 5 seconds or more, indicating that it is functioning properly. Inside of that same area are multiple switches for various operations depending upon the unit, size, shape, and purpose. They range from few to many according to the design and engineering of components. Some of these features are determined by design and size as well as purpose. Timer, date, month, day, text, location, messages, charging capability and indicators. Some has Bluetooth and water-resistant shell. design and engineering of components. Some of these features are determined by design and size as well as purpose. Timer, date, month, day, text, location, messages, charging capability and indicators. Some has Bluetooth and water-resistant shell. Various FMs have additional capabilities than the Basic, such as Bluetooth, water resistant shell, proximity alarm, vibration, volume button/switch, voice command functions, ability to record extended video/audio with up-loadable capability, varied interface capabilities with vehicles, residential and commercial security systems, deletion and remote capabilities, tamper resistant feature, flashing lights as deterrent, emergency alarm, facial recognition, and attachment clip for aftermarket FM child seat and seatbelts of a child's seat and seat belt of the inside of the backseat. The clip can be attached in various ways and in different places because the sensor is based upon proximity. Additionally, regarding the FM-OCDCM comes in a portable stand alone and is included with all the sensors which detect the oxygen and carbon dioxide exchanges within the vehicles or home is included, initially, only when it is already installed when the vehicle or home is purchased. This also includes carbo monoxide detection and alarm activation, due to its deadly results in enclosed spaces such as vehicles, homes, garages, and offices. The Base Controller Unit for all aftermarket or pre-purchased installed, interfaced units has all the capabilities of all the FM's and the ability to be enhanced as technology evolves. It is the central unit in which each FM unit can be paired for all centers, rentable per visit for all entertainment venues, educational institutions, PRP Programs, inanimate objects, various sensors detect functions of units paired, remote and battery pack, activation and deactivation indicators for transmission and reception. This is not exhaustive, as additional features, operations and elements, components, and applications. This is not limited to a Specific form disclosed and does not comprise all the elements and designs various modifications needed and required for the as the experts may specify. This only provides the basic features and abilities but does not encompass all the embodiments of the FMs. The foregoing is considered only of the principle of the FM therefore items not mentioned does not eliminate suitable and needful modifications not limiting the capability of evolution as experts deem necessary for production and optimum operations of all FM Family units and includes the ability to manually, access each unit if needed. The BCU can access, individually each unit paired with it, detect if it is operating optimally, if necessary, as in the Multi FM units

### DETAILED INFORMATION OF INVENTION

The basic FM is a proposed wearable and wireless personal safety system that would alert parents and care providers leaving a child unattended in a vehicle (or other location). It would also provide a short-range wireless proximity alert feature as well as a long-range GPS location feature in the event a child becomes lost in a public place, was abducted, or otherwise cannot be located or contacted by conventional means. As a wearable and wireless communication device for a child or other person in need of supervisory care, the proposed FM is suggested to have the physical form of a bracelet, phone, watch, ring, pendant, belt, or belt buckle etc. Wearable versions of the device may also have a locking feature to prevent unauthorized removal as well as a tampering alert feature that would be wirelessly communicated to the parent/guardian monitoring device. A seatbelt version or other versions of the proposed FM could also be within the scope and spirit of the invention for the dedicated use in a vehicle. In addition to the wearable device portion of the invention for use by children or other persons in need of supervisory care, there could be a wireless base unit portion of the invention to be used by parents and guardians. The wireless base unit could provide alert notifications, allow the setting of the proximity alert distance, and provide apparent or guardian with a means of determining the wearer's GPS location. Alerts on the parent/guardian base unit and even on the wearable device portion of the invention may be audible, visual, tactile, etc. A means of summoning public safety assistance in an emergency may also be provided and includes hard wired/wireless with features such as the wireless video camera and audio mounting features as well. Some variations are classified as Basic, Premium, Premium Plus, Vehicle, New-Born, Zero and others, including those with features of the Oxygen, Carbon Dioxide and Carbon Monoxide detection. The FM will meet the equipment authorization requirements of the Federal Communications Commission (FCC) when necessary and other regulatory bodies which could be influenced but not limited to, necessarily, in the 50 International Standards Organization (ISO)m the International Electrotechnical Commission (IEC) and the International Telecommunications Union (ITU). The FM is comprised of a program to monitor a child or an adult who may have cognitive limitations. Communications Commission (FCC) when necessary and other regulatory bodies which could be influenced but not limited to, necessarily, in the 50 International Standards Organization (ISO)m the International Electrotechnical Commission (IEC) and the International Electrotechnical Commission (IEC) and the International Telecommunications Union (ITU). The FM is comprised of a program to monitor a child or an adult who may have cognitive limitations. All the processes are not new but are adaptable for the concepts in which the FM will be used. All the features presently exist and are operational in everyday living but will be collectively in a new conceptual use within FM. All the alarms, sensors, data and more presently exists, but will be used in a new conceptual way for a new purpose of safety. The proximity alarm can be set to limit the distance allowed beyond the comfort level or level of safety for an individual that requires a limited or controlled environment. Depending on the device the FM has varied programmable distance capabilities. The two popular ways it can be used is as a single proximity alarm for a child or attached to a child's car seat. You can use it on a seat belt for anyone needing monitoring. The sensor detects the door is open and an alarm sounds Immediately the driver is notified and verbally, if you have programmed the unit with an audible message created or default, and from that moment the driver has exactly 10 seconds or immediately, to disengage the device or the authorities will automatically be notified. The reason behind the 10 seconds or immediately. Is because, unknowing of the environment inside of the car, one would not be tempted to leave the child inside the vehicle alone. The unit can be paired with most GPS automated vehicles and therefore the alert sound will be directly from the vehicle with blinking lights to help create a distraction that indicates a child is aboard. Not only can this basic unit, which is portable be used on the child and seat belt or car seat, it can be paired with sensors to interface with the vehicle present technology as well as the driver's communication device. Unless the driver and paired device is with 2 feet, the FM will be activated and alert the driver through the paired device. It is imperative that we place as much urgency in remembering first our children when we exit our vehicles. The base home unit and base unit interfaced with home or business security systems are used to monitor those needing to stay close to that home or business. This unit is used for those needing supervision such as one with dementia and it can be used in two ways. It can be paired with a person unit to allow more freedom or just with the base unit alone, smaller controlled environment. The base unit in the home has varied features.

Larger numerals and alphabets are optional for the elderly. The personal unit that it can be paired with can be made larger for those needing it and the keypad, due to sight reasons or dexterity issues. The proximity alarm alerts when someone or anything approached or pass the pre-determined proximity limit. Of all the FM's, the simplest has the most basic components and understanding, of the necessary inventive concepts for at least one of the least complicated FM units which comprises the foundation of the FM unit family. Comprised in this description does not mean that it is limited but only that it stays within the concept for all the invention and spirit thereof. It is understood that the description detailed about the FM unit is that the overall invention has other features developed and to be developed, but it is not necessary to mention to convey the spirit and claim of the purpose and capabilities of which the FM family is built. The essential features remain the same. Various embodiments or housings and advancements do not change the foundational specifications of the spirit of the FM family. The FM can have a shape of a circle which can be also in different spheres, sizes, and colors. The certain shapes and sizes will be determined by experts according to the capabilities of each different type, which still will embody the foundational properties of the FM. The FM housing is varied and multiple which include from plastic molded shapes to various other materials with metal or other properties as it relates to the design determined by the experts and the needs for the features of that unit model. The housing can have diverse distinct differences ranging from but not limited to wrist or bracelet, shapes, rings cell phones, buttons, square or rectangular wall and desk top models for seniors, all with components information, recording and control requirements. The alarm could work on one or more sensors to detect intruders or in this case associated with the proximity alarm and that causes the activation alert. There is a control panel for the alarm, the brain, that read sensor inputs, tracks, disarm and arm signals. It emits screeching, ear piercing sounds above 100 decibels.

Thereafter dispatch make verification with authorities are contacted and also an adaptable feature desired is to have the national Emergency Response Plan according to the FCC, which would include the WEA, Wireless Emergency Alerts that is used by NCMEC or the National Center for Missing Children, who manages the secondary distribution of Amber Alerts, that transmit SMS text-based system to the public for certain FMs units. The authorities are alerted from cell towers to any WEA enabled. Wireless companies are selling devices with the WEA alerts that do not track location. This is a feature working to be added. Even though the WEA is based upon location, there is no subscription, or network congestion. There is more than an English supported version and it is stated that the geo-targeting area is increasing The FM provides essential monitoring for everyone and not just the children. Coupled together, the WEA alerts children are missing, and the FM gives the location presently or last known with visuals to assist in locating the child, adult, or anything inanimate or otherwise. The switches indicate when a door is opened or closed. When a door of the vehicle in the V-FM is opened the alarm is activated to notify you that a child remains in the car or another individual your device is paired with. The OCDOM is the Oxygen & Carbon Dioxide Exchange and the COM, Carbon Monoxide feature detects invisible and odorless gases. The COM features will emit an alarm upon detection within an enclosed environment. The brain carries out the desired functions from information received from the various sensors which triggers the audible alarm, at that time, the built-in transmits signals to a central alarm system via a phone or other technological feature, depending upon the present technology adaptable and determined by skilled engineers. It has the capability of visual aid of those involved in crimes and gives a better chance of finding lost, abducted or individuals placed in harm's way, because you can see the surroundings, instead of guessing when and whether, possibly, someone may have been in an area or last seen hours before you know they are missing. The FM basic unit is comprised of an alarm, the capability to transmit and receiving messages audibly and visually, displays and transmit audibly and visually along with date with GPS info that can be seen. There are many auxiliary switches within the housed structure of the FM, which has the alarm and the other functions listed above. The FM has a clear screen with variable colors by choice and is water resistant. All functions are displayed on screen visually. The alert alarm has variable decibels which can be set and reset upon will, with personal or default messages and flashing & alternating lights to physically alert those within audible or visual range, if danger exists. Verbal commands are accepted and displayed as in a cell phone. So, it was important to have features compatible to conventional everyday use. When you press the panic button even in the FM basic unit, most are located on the inside of the inner part of The FM by opening the inside cover to expose it. A remote alarm that can be carried by a guardian comes in various shapes and can activate the paired alarm at any time. can be used by Bluetooth, cable or installed when the vehicle, or home when manufactured. The circuitry is that which is already available technologically, such as OnStar. When the guardian accesses the paired unit remotely, the signal of the paired, is received to have communication. The remote or manual sensor can sense the that is wireless transmit and the unit temperature of the inside of a vehicle and transmit the data wirelessly to anyone paired with the unit such as a parent to their device. If an individual is locked in a vehicle, you can know the temperature and so can the authorities. The alarm would alert inside and outside of the vehicle to alert anyone nearby as well. There is a cloud storage and local storage for any data record or seen when the FM is accessed remotely to check on any individual in danger. There performs in and outside of structures. Contactless temperature measurement processes are already in use world-wide and will be used in a new concept with the FM. Temperature measurement is used in autos, aerospace, homes and more, so this is not a new process but new concept of use with the FM. The FM locking mechanism is on the opposite side of the clip and is only safely and effectively unlocked when the paired unit is within the predetermined distance to avoid notification to the authorities and ink spillage. The vibrator, receiver, transmitter, and all features mentioned is positioned within the wrist FM unit, as the others also can be locked or unlocked by the paired unit of the guardian wirelessly if needed. All audio and visual with date is transmitted wirelessly. There is a microprocessor within each FM invention with upgradeable features as well as additional features on other models, however the spirit of the FMs, is the same as in the basic components and elements of the basic unit. The FM has a backlight, speaker, ability to record, store data such as the pre-programmed phone numbers, messages, and live transmittable video if a child or adult needs assistance. The GPS gives location to help find a child or whoever may be lost or even a pet. The Global Positioning System that is in everyday use makes this invention easily adaptable. The child or adult's unit coordinates will have that data displayed according to their location. The FM has the power source within the housed unit which can be solar, electric, battery or as technology advances according to the designs dictated by skilled experts. The paired unit can see on its display the status of any unit it is paired with and activate and deactivate it or send data to authorities of the unit it is paired with is unable to do so. This is a safety function in case of emergencies. The self-contained FMs are used for proximity alerts without a paired unit. The signal can be electric, radio or IR and as the technology evolves for safety purposes for these units. In the summary, the abilities of each of the various FM's are in more detail of their necessities and reasoning. All, however, function with much the same foundation and spirit of the less enhanced model. For definition and explanation, the use of the word “Comprising”, does not limit the invention only to the basic unit. All features within the unit are presently available for everyday use and therefore, it is easily adaptable for those who need what it can provide. It has the capability of having a selection process of numbers or names or any information programmed into system for notification purposes or transmission, or reception/units paired with another FM which has wireless capabilities with the base controller unit and can save, replay, forward, store, record, focus and display what has been received through transmissions.

The FM testing method occurs when the panic button inside of the enter side of the unit next to the arm is opened and pressed. It will beep once is you hold it for 5 seconds or more, indicating that it is functioning properly. Inside of that same area are multiple switches for 480 various operations depending upon the unit, size, shape, and purpose. They range from few to many according to the claim listed there.

1. The device has an inter and outer base control module with a multifunctioning sensor tracking system comprising multiple elements with varied housing, color, designs, and shapes.

2. I claim the subject matter of claim 1, wherein sensing of distance animate and inanimate objects and gases.

3. I claim the subject matter of claim 1, wherein the housing consists of varied water-resistant units with protected display screen.

4. I claim the subject matter of claim 1 further comprising of a tamperproof locking mechanism and one or more Ink Release Chambers.

5. I claim the subject matter of claim 1, wherein are tamper proof-locking mechanisms has a method to release locking mechanisms.

6. I claim the subject matter of claim 1 further comprising of a construction to have interface capabilities, Bluetooth, cable and auxiliary.

7. I claim the subject matter of claim 1 further comprising of attachment clips.

8. I claim the subject matter of claim 1 further comprising of construction to allow a camera system, audio attachments comparable devices as technology evolves.

9. I claim the subject matter in claim 1 wherein the comparable devices have the capability to download and upload data of devices to various locations.

10. I claim the subject matter of claim 1, wherein data has a method of live feed.

11. I claim the subject matter of claim 1 has a Grid Eye.

12. I claim the subject matter in claim 1 has a method to detect and auto-detect.

13. I claim the subject matter in claim 1, wherein the detection, has a method of biometric technology, finger printing and facial recognition.

14. I claim the subject matter of claim 1, wherein is detection, has a method of auto activate.

15. I claim the subject matter of claim 1, wherein is detection, has visual and audio alerts.

16. I claim the subject matter of claim 1, wherein is detection has a method to detect carbon monoxide (OCO) or (OCDM) and other gases and exchanges.
